(19) United States
(12) Patent Application Publication
(10) Pub. No.: US 2018/0092036 A1
(43) Pub. Date: Mar. 29, 2018

(54) MULTIPLEXING SCHEME TO TRANSMIT NARROWBAND WAKE UP PACKETS AND NARROWBAND BEACONS WITHIN 802.11AX OFDMA ALLOCATIONS

(71) Applicant: INTEL CORPORATION, Santa Clara, CA (US)

(72) Inventors: Shahrnaz AZIZI, Cupertino, CA (US); Minyoung PARK, Portland, OR (US); Thomas J. KENNEY, Portland, OR (US); Eldad PERAHIA, Portland, OR (US); Ilan SUTSKOVER, Hadera (IL)

(21) Appl. No.: 15/278,489

(22) Filed: Sep. 28, 2016

(51) Int. Cl. H04W 52/02; H04W 72/04

(52) U.S. Cl. CPC H04W 52/0235; H04W 84/12; H04W 72/0473; H04W 72/0406

(57) ABSTRACT

Devices, methods, and media described herein can employ the central 26-tone allocation of 802.11ax for transmission of NB beacons and wake-up packets. Having a dedicated narrowband channel for transmission of NB beacons and/or wake-up packets improves the overall spectrum efficiency. Further, the embodiments may use the central 26-tone subchannel for LP-WUR and legacy IEEE 802.11ax OFDMA transmission, but not for the LP-NB IoT devices that have a OFDM waveform. This configuration reduces the implementation cost and test/certification time & cost of IoT devices.

### TECHNICAL FIELD

An exemplary aspect is directed toward communications systems. More specifically an exemplary aspect is directed toward wireless communications systems and even more specifically to IEEE (Institute of Electrical and Electronics Engineers) 802.11 wireless communications systems. Even more specifically, exemplary aspects are at least directed toward one or more of IEEE (Institute of Electrical and Electronics Engineers) 802.11n/ac/ax/ . . . communications systems and in general any wireless communications system or protocol, such as 4G, 4G LTE, 5G and later, and the like.

### BACKGROUND

Wireless networks transmit and receive information utilizing varying techniques and protocols. For example, but not by way of limitation, two common and widely adopted techniques used for communication are those that adhere to the Institute for Electronic and Electrical Engineers (IEEE) 802.11 standards such as the IEEE 802.11n standard, the IEEE 802.11ac standard and the IEEE 802.11ax standard.

The IEEE 802.11 standards specify a common Medium Access Control (MAC) Layer and Physical Layer (PHY), which provides a variety of functions that support the operation of IEEE 802.11-based Wireless LANs (WLANs) and devices. The MAC Layer manages and maintains communications between IEEE 802.11 stations (such as between radio network interface cards (NIC) in a PC or other wireless device(s) or stations (STA) and access points (APs)) by coordinating access to a shared radio channel and utilizing protocols that enhance communications over a wireless medium.

IEEE 802.11ax is the successor to IEEE 802.11ac and is proposed to increase the efficiency of WLAN networks, especially in high density areas like public hotspots and other dense traffic areas. IEEE 802.11ax also uses orthogonal frequency-division multiple access (OFDMA), and related to IEEE 802.11ax, the High Efficiency WLAN Study Group (HEW SG) within the IEEE 802.11 working group was considering improvements to spectrum efficiency to enhance system throughput/area in high density scenarios of APs (Access Points) and/or STAs (Stations).

New devices are immerging that require a low power (LP) data transfer mode for Wi-Fi. A main use case of LP is the enabling of battery operated sensors and Internet-of-Things (IoT) devices in the smart home, the smart building management, industrial automation, etc. For example, a Wi-Fi transceiver can be built into a temperature sensor in a HVAC duct, which cannot be reached easily, and hence requires on the order of five years of battery life. The new system allowing for LP data transfer will have to address legacy devices and coexistence that was not a concern in the IEEE 802.11ah development.

LP devices may be allowed to operate with a bandwidth smaller than 20 MHz, which can enable low power data transfer. Different from IEEE 802.11ax (HE), where operation under OFDMA allowed smaller bandwidths, LP narrowband (LP-NB) devices need to be enabled to operate only with a bandwidth smaller than 20 MHz, for example, approximately 2 MHz to 2.6 MHz to be compatible with 802.11 ax OFDMA allocation. There may be many narrow band (NB) devices within IEEE 802.11ax networks where there are 9 different NB subchannels for operation of LP-NB devices. The APs needs to transmit NB beacons and wake-up packets to these new devices at all different subchannels. This requirement introduces extra overhead per each subchannel.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an embodiment of an environment associated with the embodiments presented herein;

FIG. 2 illustrates an embodiment of a center subchannel used for control of low-power NB STAs (LP-NB STAs);

FIG. 3 illustrates an embodiment of a low-power wake-up radio packet;

FIG. 4 illustrates an embodiment of a bandwidth allocation having wake-up, LP-NB, and IEEE 802.11ax allocations;

FIG. 5 illustrates an embodiment of a bandwidth allocation LP-NB multicast/broadcast in the central 26-tone allocation;

FIG. 6 is a flowchart outlining an exemplary technique for controlling LP-NB communications with a center subchannel from the perspective of the LP-WUR;

FIG. 7 is a flowchart outlining an exemplary technique for controlling LP-NB communications with a center subchannel from the perspective of the un-associated LP-NB device;

FIG. 8 is a flowchart outlining an exemplary technique for controlling LP-NB communications with a center subchannel from the perspective of the associated LP-NB device;

FIG. 9 is a flowchart outlining an exemplary technique for controlling LP-NB communications with a center subchannel from the perspective of the AP;

FIG. 10 is an illustration of the hardware/software associated with a AS, LP-NB STA, and/or AP.

### DESCRIPTION OF EMBODIMENTS

To reduce power consumption, LP devices could use a low-power wake-up receiver (LP-WUR). The LP-WUR provides a low-power solution (e.g., ˜100 μW in active state) for always-on Wi-Fi (or Bluetooth™) connectivity of wearable, IoT, and other emerging devices that will be densely deployed and used in the near future.

The 80211ax communication framework has 26-tone subchannels on two different physical bandwidths: (1) 26×20 MHz/256=2.03125 MHz (2) the central 26-tone is (26+7 DC nulls)×20 MHz/256=2.578125 MHz. This configuration requires narrowband LP-NB devices to use a different set of filtering and tone-processing when using the central 26-tone allocation vs. non-central allocation, which adds to the implementation cost and time, and cost of test and certification for LP-NB devices.

The embodiments herein can employ the central 26-tone allocation of IEEE 802.11ax for transmission of NB beacons and wake-up packets. Having a dedicated narrowband channel for transmission of NB beacons and/or wake-up packets improves the overall spectrum efficiency. Further, the embodiments use the central 26-tone for LP-WUR and legacy IEEE 802.11ax OFDMA transmission, but not for the LP-NB IoT devices that have a OFDM waveform. This configuration reduces the implementation cost and test/certification time & cost of IoT devices.

Generally, the novel configuration utilizes the central 26-tone OFDMA allocation of IEEE 802.11ax bandwidth differently when LP-NB Wi-Fi IoT devices are integrated into the network. When integrated, the network can utilize the central 26-tone for transmission for narrowband wake-up packets, narrowband beacons, or other network wide data transfer and narrowband broadcasted wake-up packets. If the waveform for LP-NB devices is OFDM, then those devices may never operate on the central 26-tone because those devices have only bandwidth compatible with contiguous 26 tones. The HE-SIG-B of IEEE 802.11ax+ physical layer convergence procedure (PLCP) protocol data units (PPDUs) can configure and signal on the central allocation for a DL transmission to a certain receiver-ID. The legacy IEEE 802.11ax devices can assume this transmission is an OFDMA transmission to a device, while IEEE 802.11ax+/LRLP/LP devices, which are tuned to the central allocation, can detect their preamble in that subchannel and can continue with packet acquisition and detection.

Some embodiments may involve wireless communications according to one or more other wireless communication standards. Examples of other wireless communications technologies and/or standards that may be used in various embodiments may include—without limitation—other IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11ad, IEEE 802.11af, IEEE 802.11 ah, and/or IEEE 802.11ay standards, Wi-Fi Alliance (WFA) wireless communication standards, such as, Wi-Fi, Wi-Fi Direct, Wi-Fi Direct Services, Wireless Gigabit (WiGig), WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards such as those embodied in 3GPP Technical Report (TR) 23.887, 3GPP Technical Specification (TS) 22.368, and/or 3GPP TS 23.682, and/or near-field communication (NFC) standards such as standards developed by the NFC Forum, including any predecessors, revisions, progeny, and/or variants of any of the above.

Some embodiments may involve wireless communications performed according to one or more broadband wireless communication standards. For example, various embodiments may involve wireless communications performed according to one or more 3rd Generation Partnership Project (3GPP), 3GPP Long Term Evolution (LTE), and/or 3GPP LTE-Advanced (LTE-A) technologies and/or standards, including their predecessors, revisions, progeny, and/or variants. Additional examples of broadband wireless communication technologies/standards that may be utilized in some embodiments may include—without limitation—Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS), IEEE 802.16 wireless broadband standards such as IEEE 802.16m and/or IEEE 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their predecessors, revisions, progeny, and/or variants.

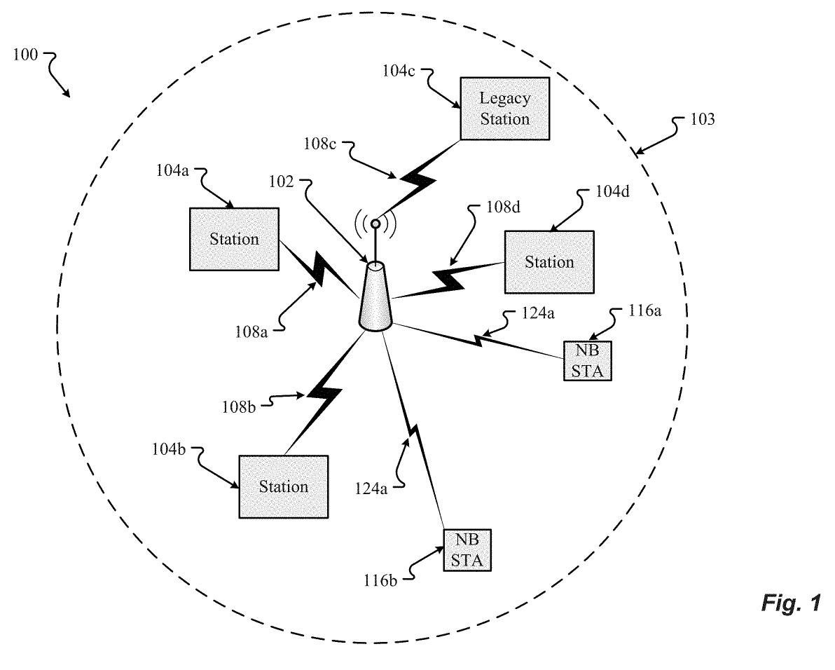

FIG. 1 illustrates an example of an operating environment 100 which may be representative of various configurations described herein. The WLAN 103 may comprise a basic service set (BSS) that may include a master station 102 and one or more other stations (STAs) 104. The master station 102 may be an access point (AP) using the IEEE 802.11 to transmit and receive. Hereinafter, the term AP will be used to identify the master station 102. The AP 102 may be a base station and may use other communications protocols as well as the IEEE 802.11 protocol. The IEEE 802.11 protocol may be the IEEE 802.11ax or later standard. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO).

The STAs 104 may include one or more high-efficiency wireless (HEW) (as illustrated in, e.g., the IEEE 802.11ax standard) STAs 104 a, b, d and/or one or more legacy (as illustrated in, e.g., the IEEE 802.11n/ac standards) STAs 104c. The legacy STAs 104c may operate in accordance with one or more of IEEE 802.11 a/b/g/n/ac/ad/af/ah/aj, or another legacy wireless communication standard. The HEW STAs 104 a, b, d may be wireless transmit and receive devices, for example, a cellular telephone, a smart telephone, a handheld wireless device, wireless glasses, a wireless watch, a wireless personal device, a tablet, or another device that may be transmitting and receiving using a IEEE 802.11 protocol, for example, the IEEE 802.11ax or another wireless protocol. In the operating environment 100, an AP 102 may generally manage access to the wireless medium in the WLAN 103.

Within the environment 100, one or more STAs 104a, 104b, 104c, 104d may associate and/or communication with the AP 102 to join the WLAN 103. Joining the WLAN 103 may enable STAs 104a-104d to wirelessly communicate with each other via the AP 102, with each other directly, with the AP 102, or to another network or resource through the AP 102. In some configurations, to send data to a recipient (e.g., STA 104a), a sending STA (e.g., STA 104b) may transmit an uplink (UL) physical layer convergence procedure (PLCP) protocol data unit (PPDU) comprising the data to AP 102, which may then send the data to the recipient STA 104a, in a downlink (DL) PPDU.

In some configurations, a frame of data transmitted between the STAs 104 or between a STA 104 and the AP 102 may be configurable. For example, a channel used in for communication may be divided into subchannels that may be 20 MHz, 40 MHz, or 80 MHz, 160 MHz, 320 MHz of contiguous bandwidth or an 80+80 MHz (160 MHz) of non-contiguous bandwidth. Further, the bandwidth of a subchannel may be incremented into 1 MHz, 1.25 MHz, 2.03 MHz, 2.5 MHz, 5 MHz and 10 MHz bandwidths, or a combination thereof, or another bandwidth division that is less or equal to the available bandwidth may also be used. The bandwidth of the subchannels may be based on a number of active subcarriers. The bandwidth of the subchannels can be 36, 52, 106, etc active subcarriers or tones that are spaced by 20 MHz. In some configurations, the bandwidth of the subchannels is 256 tones spaced by 20 MHz. In other configurations, the subchannels are a multiple of 26 tones or a multiple of 20 MHz. A 20 MHz subchannel may also comprise 256 tones for use with a 256 point Fast Fourier Transform (FFT).

At a given point in time, multiple STAs 104a-d, in the WLAN 103, may wish to send data. In some configurations, rather than scheduling medium access for STAs 104a-d in different respective UL time intervals, the AP 102 may schedule medium access for STAs 104a-d to support UL multi-user (MU) transmission techniques, according to which multiple STAs 104a-d may transmit UL MU PPDUs to the AP 102 simultaneously during a given UL time interval. For example, by using UL MU OFDMA techniques during a given UL time interval, multiple STAs 104a-d may transmit UL MU PPDUs to AP 102 via different respective OFDMA resource units (RUs) allocated by AP 102. In another example, by using UL MU multiple-input multiple-output (MU-MIMO) techniques during a given UL time interval, multiple STAs 104a-d may transmit UL MU PPDUs to the AP 102 via different respective spatial streams allocated by the AP 102.

To manage access, the AP 102 may transmit a HEW master-sync transmission, which may be a trigger frame (TF) or a control and schedule transmission, at the beginning of the control period. The AP 102 may transmit a time duration of the TXOP and sub-channel information. During the HEW control period, HEW STAs 104 a, b, d may communicate with the AP 102 in accordance with a non-contention based multiple access technique such as OFDMA or MU-MIMO. This HEW technique is unlike conventional WLAN communications in which devices communicate in accordance with a contention-based communication technique, rather than a multiple access technique. During the HEW control period, the AP 102 may communicate with stations 104 using one or more control frames, and the STAs 104 may operate on a sub-channel smaller than the operating range of the AP 102. Also, during the control period, legacy stations may refrain from communicating by entering a deferral period.

During the HEW master-sync transmission, the STAs 104 may contend for the wireless medium with the legacy devices 106 being excluded from contending for the wireless medium during the HEW master-sync transmission. The trigger frame used during this HEW master-sync transmission may indicate an UL-MU-MIMO and/or UL OFDMA control period. The multiple-access technique used during the control period may be a scheduled OFDMA technique, or alternatively, may be a TDMA technique, a frequency division multiple access (FDMA) technique, or a SDMA technique.

The AP 102 may also communicate with legacy stations and/or HEW stations 104 in accordance with legacy IEEE 802.11 communication techniques. In some configurations, the AP 102 may also be configurable to communicate with HEW stations 104 outside the HEW control period in accordance with legacy IEEE 802.11 communication techniques, although this is not a requirement.

The environment 100 may also include one or more LP-NB STAs, represented by LP-NB STA devices 116a, 116b. The LP-NB STA devices 116a, 116b receive and transmit using only a narrow bandwidth, e.g., 2 MHz. Thus, the LP-NB STA devices may be assigned a particular tone or RU by the AP for DL, UL, and/or wake-up signaling.

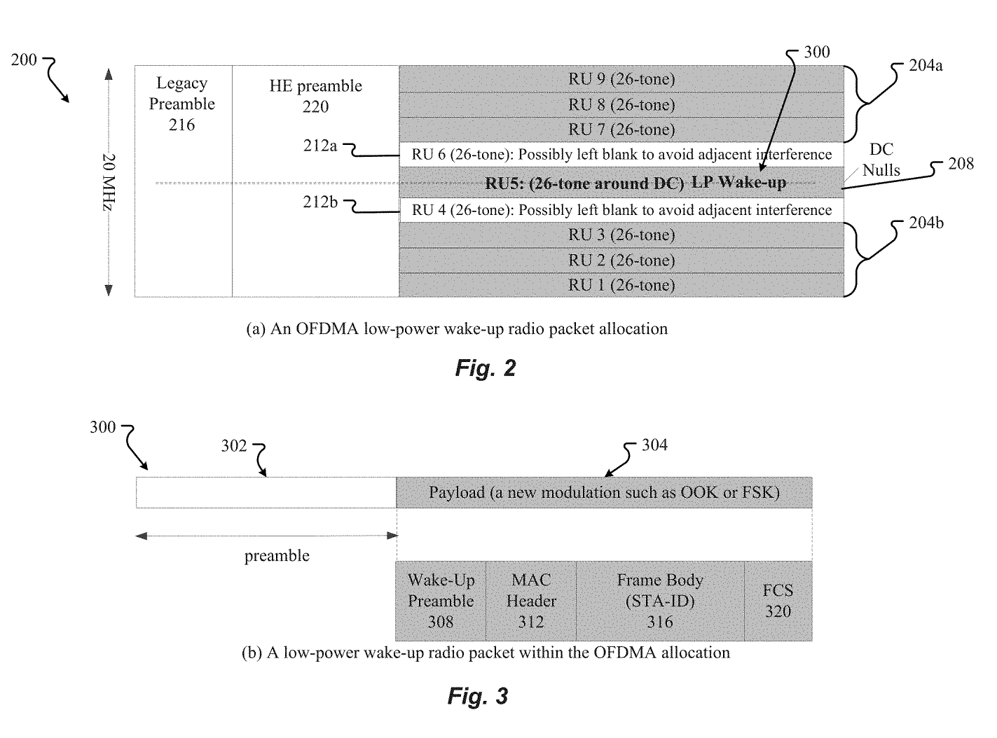

An embodiment of a bandwidth allocation 200 is shown in FIG. 2. The allocation 200 utilizes the OFDMA subchannels 204 of IEEE 802.11ax spectrum to multiplex low power/low rate data transfer of the LP-NB devices within the IEEE 802.11ax network. Future IEEE 802.11ax+PPDUs can configure NB subchannels in their HE signal field B (HE-SIG-B) as an OFDMA transmission. Therefore, the NB data transfer will be transparent to legacy IEEE 802.11ax devices. However, each LP-NB device needs to receive NB management and control packets, such beacons, during their active mode of operation and during sleep periods. It is also envisioned that all Wi-Fi devices may equipped with LP-WURs to reduce their power consumption. LP-WUR can operate with a bandwidth smaller than 20 MHz.

FIG. 2 shows a bandwidth spectrum multiplexing with IEEE 802.11ax data, and FIG. 3 shows a packet format of the wake-up packets. The spectrum and wake-up packet format may be as described in U.S. patent application Ser. No. 14/998,242, entitled “APPARATUS, SYSTEM, AND METHOD OF COMMUNICATING A WAKEUP PACKET,” filed on Dec. 26, 2015 which is incorporated herein by reference for all that it teaches and for all purposes. The wake-up packet 300 is transmitted at the central 26-tone subchannel 208, and the subchannels 212a, 212b on both sides of the central 26-tone 208 can be left black to reduce the adjacent subchannel interference.

As can be seen in FIG. 2, the IEEE 802.11ax compatible wake-up packet was assumed to exactly occupy the same subcarriers as of the IEEE 802.11ax 26-tone RU 208 (i.e., RU5), thereby leaving the seven DC nulls intact. There may be more or fewer guard band 212 than those shown in FIG. 2, depending on what is needed to minimize degradation for a wake-up packet 300 within the OFDMA structure 200

The AP 102 herein can transmit the wake-up packet 300 at the center of the band 208 (e.g., at or around the dashed lines in the FIG. 2) utilizing the DC nulls. Since the LP-WUR uses OOK (On/Off Key) modulation, then a demodulator of the LP-WUR can utilize an envelope detector. Using such a detector, the energy folded into the DC region by a direct conversion receiver will not impact its performance as long as the DC value is considered in setting the detection threshold. The impact on IEEE 802.11ax receivers is negligible. By using an envelope detector, the setting of the detection threshold will govern the accuracy of detection of the wake-up packet.

One exemplary embodiment transmits the 26×20 MHz/256=2.03125 MHz wake-up pulse at the center of (or in general anywhere within) the band 208 (e.g., RU5) without requiring the nulling of the seven DC subcarriers.

This moves the wakeup pulse inward leaving larger guard bands between the wake-up packet and the adjacent OFDMA allocations. This signal arrangement improves the LP-WUR detection performance and can allow assignment of more RUs to IEEE 802.11ax OFDMA PPDUs, which can improve overall system throughput and efficiency.

The solution shown in FIG. 2 may require at least two 26-tone subchannels 212a, 212b to be left as guard bands on each side of central wake-up pulse 300 with the assumption that there is a large amount of phase noise experienced at the LP-WUR receiver.

Hence, while the solution shown in FIG. 2 has its applications, the solution can be further improved to increase spectrum efficiency. One exemplary solution has the LP-WUR set with a more stringent limit on adjacent channel rejection. This setting in turn requires much better phase noise and sharper filtering for the LP-WUR, both of which are expensive for the LP-WUR in terms of power consumption, and therefore defeats the whole motivation for having a LP-WUR.

However, an additional or alternative embodiment may use the DC null tones for the LP-WUR to improve the adjacent resource unit interference rejection. The exemplary embodiment can be viewed as a method of trading-off between a LP-WUR phase noise requirement and the number of IEEE 802.11ax allocations that can be multiplexed with the wake-up packet in the same PPDU.

As mentioned above, the AP 102 may transmit the 26×20 MHz/256=2.03125 MHz wake-up pulse 300 at the center of the band 208 without nulling the seven central subcarriers at and around DC. The proposed subcarrier indices corresponding to the IEEE 802.11ax RUs and wake-up pulse may be as defined in Table 1:

TABLE 1
RU Type

| 26-subcarrier | RU1 (11ax) | RU2 (11ax) | RU3 (11ax) | RU4 |
|---|---|---|---|---|
| | [−121: −96] | [−95: −70] | [−69: −43] | (guard band) |
| | | | | [−42: −17] |
| | RU5 (guard subcarriers, wake-up, guard subcarriers) | | | |
| | [−16: −13, −12: 13, 14: 16] (or [−16: −14, −13: 12, 13: 16]) | | | |
| | RU6 | RU7 (11ax) | RU8 (11ax) | RU9 (11ax) |
| | (guard band) | [43: 69] | [70: 95] | [96: 121] |
| | [17: −42 | | | |

The LP-WUR can receive OOK modulated signals. Each OOK pulse occupies 26 subcarriers as illustrated in Table 1. Since the wake-up packet 300 can use OOK modulation, then the demodulator of the LP-WUR can utilize an envelope detector as discussed. Using such a detector, the energy folded into the DC region by a direct conversion receiver will not impact the LP-WUR's performance. The DC value only impacts selection of the detection threshold. Once the threshold is set correctly, the DC value would not impact its packet error performance (PER). Since the use of envelope detectors is well known, a detailed discussion thereof is not required.

To avoid having a long wake-up packet transmission, the AP 102 can keep the duration of wake-up pulse (OOK pulse) equal to 1×OFDM Symbol (1×Sym) duration. This configuration will result in only 6 or 7 non-zero subcarriers for the wake-up pulse. The reason for this result is that 1×Sym is equivalent to a 64-point Fast Fourier Transform (FFT) of the 256-point FFT of IEEE 802.11ax and that a 52-tone RU in a 256 pt-FFT will be equivalent to 13 tones in 64 pt-FFT, and hence 26-tones will be 6 or 7 subcarriers in 64-pt FFT.

With this configuration mind, the eventual subcarrier assignment in a 256 pt-FFT for the wake-up pulse can look like [×1, 0, 0, 0, ×2, 0, 0, 0, ×3, 0, 0, 0, 0, 0, 0, 0, 0, ×4, 0, 0, 0, ×5, 0, 0, 0, ×6] (where xn is a non-zero value), which effectively has null subcarriers in the center.

As shown in FIG. 2, the wake-up packet transmission 300 is aligned with the data portion of the HE-packet. Therefore, IEEE 802.11ax receivers will be able to receive and decode the preamble portion for the entire bandwidth, which is critical to having the LP-WUR not introduce any degradation to the IEEE 802.11ax PPDUs. After the HE-SIG-B field of the preamble is decoded, the IEEE 802.11ax receiver knows which RU is assigned to that STA 104, if any.

FIGS. 1, 2, and 4 show where the wake-up packet 300 is multiplexed with IEEE 802.11ax OFDMA PPDUs. The IEEE 802.11ax STAs 104, 116 that have decoded the HE-SIG-B and know that there are no RUs assigned to them, can set their NAV timers and will terminate the receive operation. However, the IEEE 802.11ax or NB receiver 104, 116 that does have an RU assigned to it will continue decoding the packet after filtering and considering only the assigned RU. This configuration means that the IEEE 802.11ax receiver may ignore the central 26-tone anyway regardless of the value at the DC subcarrier. The questions are then:

i) whether the DC value would impact the ADC (Analog to Digital Converter) dynamic range since the AGC (Automatic Gain Control) is already adjusted based on the preamble—which has not carried OOK modulated symbols. It is noted that the IEEE 802.11ax OFDMA receiver will re-adjust the AGC based on HE-STF corresponding to its RU assignment. Hence, there will be no negative impact from non-nulls at DC;

ii) will there be any DC leakage from the wake-up pulse to the received RU due to the CFO (Carrier Frequency Offset)? According to Table 1, the closest subcarrier indices of IEEE 802.11ax RUs to the DC are at indices −43 (RU 3) and +43 (RU 7). Therefore, even the largest possible CFO will cause negligible leakage. The above technical proposal then at least will not have a negative impact on IEEE 802.11ax receivers.

Another aspect of the embodiments presented herein is that the seven central subcarrier indices can be considered part of wake-up pulse 300. By doing so, the wake-up pulse 300 is pushed inward toward the center of the band leaving more subcarriers as guard tones between the wake-up packet 300 and IEEE 802.11ax OFDMA allocations 204. This arrangement at least enables a trade-off between multiplexing IEEE 802.11ax STAs at RUs 3 and 7 vs. a phase noise requirement at the LP-WUR. Overall, the technology provides a trade-off between power consumption at LP-WUR vs. spectrum utilization given certain adjacent subchannel rejection requirements.

As discussed however, the wake-up pulse 300 need not be directly at the center of the band. Variations from the center of the band 208 would still allow more subcarriers as guard tones between the wake-up packet and IEEE 802.11ax OFDMA allocations, thereby still improving spectrum utilization.

The wake-up packet 300 may be as shown in FIG. 3. The payload of the packet 300 may follow the preamble 302, which can follow the legacy preamble 216 and/or the HE preamble 220. In some configurations, the payload 304 may be modulated with OOK or FSK. The payload 304 can include one or more of, but is not limited to, a wake-up preamble, a MAC header 312, a Frame Body (STA ID) 316, and/or a frame check sequence (FCS) 320.

The wake-up preamble 308 can include any data or information to indicate to a NB STA 316 that the packet 300 is a wake-up packet or pulse 300. The MAC header 312 can include the MAC address for the STA 116 or other information. The frame body 316 can include one or more STA identifiers (IDs) that can identify the NB STAs 116 to be awoken. Thus, two or more NB STA IDs may multicast the wake-up packet 300 to multiple STAs 116. The frame body 316 may include other information, for example, the assigned NB channel for the NB STA 116, how to conduct communications after waking up, etc. The FCS 320 can include any information to check the wake-up packet 300 contents.

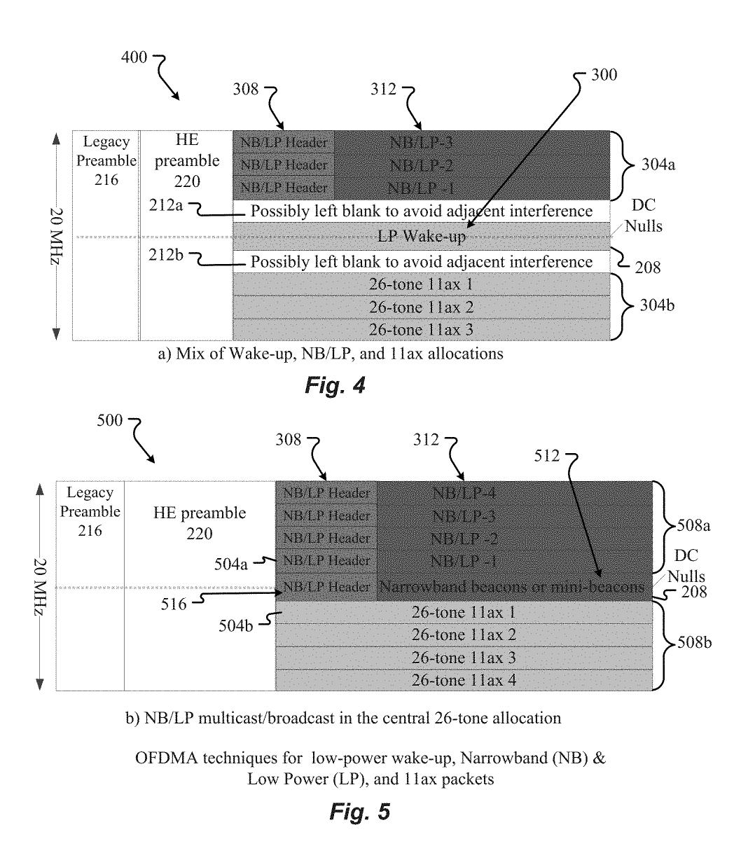

Additional or alternative embodiments of the above are shown in FIGS. 4 and 5. The additional or alternative embodiments expand on the configuration described in conjunction with FIGS. 2 and 3 to include multiplexing LRLP/Future-LP packets and to integrate transmission of narrowband broadcast/multicast LRLP/Future-LP packets 304 with a wake-up packet 300 at the central RU (RU5) 208, IEEE 802.11ax OFDMA subchannel 208 as shown in FIGS. 2 and 4.

The multiplexing scheme 400, shown in FIG. 4, provides for the assignment of one or more STAs 116 to a NB channel 304a. Each RU 304a can include data for a different STA 116. In the configuration shown in FIG. 4, LP wake-up signals 300 may still be transmitted on the center subchannel 208 and guard bands 212 may prevent inter-channel interference.

The NB data in the RUs of portion 304a can include wake-up packets 300 or other data directed to STAs 116 that have been pre-assigned to those RUs. As such, the NB STA 116 may need to listen on that RU rather than the center subchannel. The RU can transmit data packets including LP-NB headers 308, which include necessary data about the transmission, and payloads 312, which include the data. A second portion of the bandwidth 304b may be used for IEEE 802.11ax data.

Another multiplexing scheme 500 may be as shown in FIG. 5. The scheme 500 again provides for the assignment of one or more STAs 116 to NB channels 508a. However, the guard band 212a is now eliminated and assigned as RU 504a to a NB STA 116. Each RU 508a can include data for a different STA 116. In the configuration shown in FIG. 5, LP wake-up signals 300 may be transmitted on an RU for a specific NB STA 116. In the center subchannel 208, NB packets are sent as multicast or broadcast transmissions. The packets can include a LP-NB header 516 and payload 512. NB beacons or mini-beacons 512 can be sent as part of or in lieu of the NB data. Beacons can alert NB STAs 116 of the presence of the AP 102 and begin the process of associating NB STAs with the AP 102. Further, probe requests and probe responses may be send on the center subchannel 208 until a NB STA 116 is associated with the AP 102 and is assigned an RU 508.

The NB data in the RUs of portion 304a can include wake-up packets 300 or other data directed to STAs 116 that have been pre-assigned to those RUs. As such, the NB STA 116 may need to listen on that RU rather than the center subchannel 208. The RU can transmit data packets including LP-NB headers 308, which include necessary data about the transmission, and payloads 312, which include the data. A second portion of the bandwidth 304b may be used for IEEE 802.11ax data. The second portion of the bandwidth 508b may also eliminate the guard channel 212b and replace it with an assignable RU 504b. With the beacons or other data on the center subchannel 208 being less prone to interchannel interference, the bandwidth 500 may be more efficiently allocated.

The multiplexing schemes 400/500 may be interchangeably employed by an AP 102. Thus, for a first period of time, the AP 102 could use scheme 400 to broadcast wake-up packets 300 on the center subchannel 208. At other times, the AP 102 may use the scheme 500 where the RUs 508a, 508b are allocated as usable RUs for data transfer. In this way, the AP 102 can most efficiently use the available bandwidth.

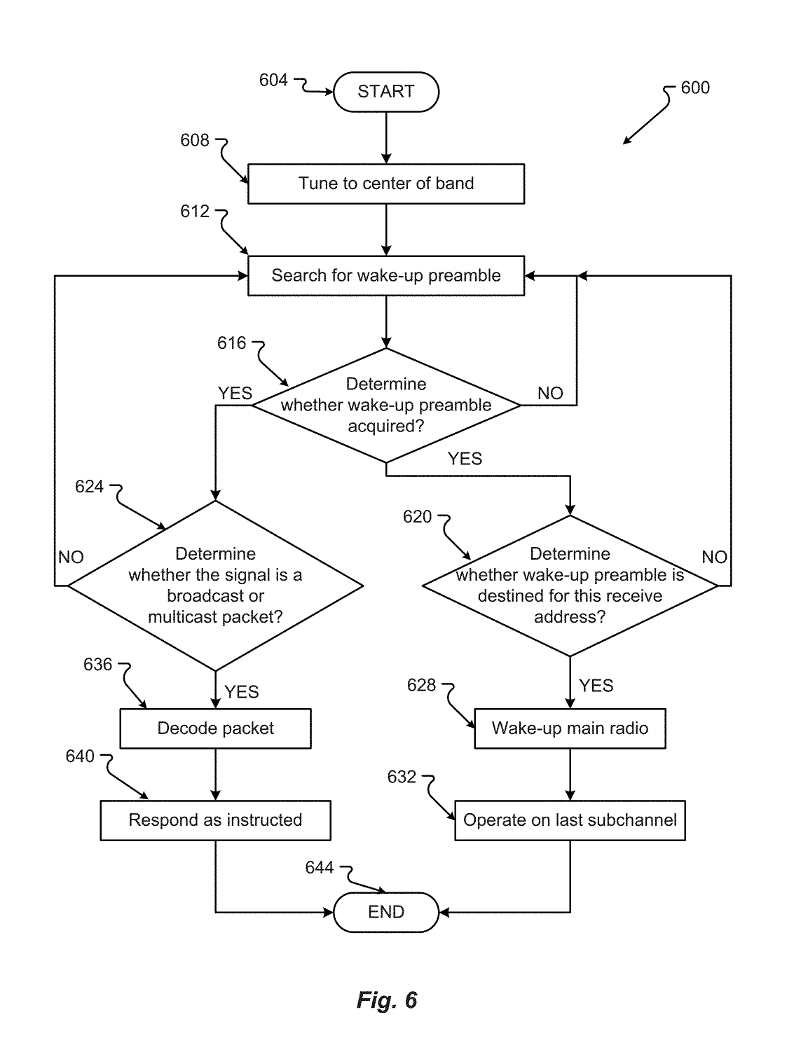

An embodiment of a method 600 for conducting NB communications may be as shown in FIG. 6. The method 600 may be from the perspective of the LP-WUR 1056 (shown in FIG. 10). A general order for the steps of the method 600 is shown in FIG. 6. Generally, the method 600 starts with a start operation 604 and ends with an end operation 644. The method 600 can include more or fewer steps or can arrange the order of the steps differently than those shown in FIG. 6. The method 600 can be executed as a set of computer-executable instructions executed by a computer system or processor and encoded or stored on a computer readable medium. Hereinafter, the method 600 shall be explained with reference to the systems, components, circuits, modules, software, data structures, signalling processes, etc. described in conjunction with FIGS. 1-5 and 10.

In step 608, the LP-WUR 1056, of the NB STA 116, is tuned to the center of the band 208. The LP-WUR 1056 searches for wake-up preamble 308, in step 612. Based on the searching, the controller 1070 determine if whether a wake-up preamble 308 is acquired, in step 616. If no wake-up packet 308 is acquired, the method 600 proceeds NO back to step 612 to continue searching the center subchannel 208 for a wake-up preamble 308.

In contrast, if a wake-up packet 308 is acquired, the method 600 proceeds YES, and the NB STA 116 performs one or more of the following two determinations. First, the STA 116 can determine whether the wake-up preamble 308 is destined for the STA's LP-WUR 1056, in step 620. The controller 1070 may analyse data in the preamble 308, the MAC header 312, or the frame body 312 to determine if the NB wake-up is meant for that STA 116 by comparing any identifiers in the wake-up packet 300 with known identifiers stored in memory 1016. If the wake-up packet 300 is not destined for the STA 116, the method 600 proceeds NO to step 612 to continue to search for a wake-up preamble 308. If the packet 300 is addressed to the STA 116, the method 600 proceeds YES to step 628.

Second, the STA 116 can determine if the wake-up signal is a broadcast or multicast packet, in step 624. Again, the controller 1070 may analyse data in the preamble 308, the MAC header 312, or the frame body 316 to determine if the NB wake-up is a broadcast or multicast packet. By comparing any identifiers or in the wake-up packet 300 with known identifiers stored in memory 1016 or by identifying information in the packet 300 that indicates the packet 300 is a broadcast or multicast packet 300, the STA 116 can recognize that the packet 300 is meant for the STA 116. If the wake-up packet 300 is not a multicast or broadcast packet meant for the STA 116, the method 600 proceeds NO to step 612 to continue to search for a wake-up preamble 308. If the packet 300 is a broadcast or multicast packet meant for the STA 116, the method 600 proceeds YES to step 636,

In step 628, the controller 1070 can signal the main radio 1070 awaken. The controller 1070 may also instruct the radio to operate on the last subchannel 304a, 508a the STA 116 was using before entering the sleep mode, in step 632.

If, the wake-up packet 300 is not a unicast to the STA 116, but the packet 300 belongs to a multicast group or the packet 300 is a broadcast wake-up packet. The LP-WUR 1056 can decode the packet 300, in step 636, and may react according to instructions obtained from the packet 300 or according to prior information or configuration, in step 640. For example, the LP-WUR 1056 can wake up the main radio 1070, after decoding a multicast/broadcast wake-up packet, the LP-WUR 1056 may set internal timers to trigger an event at a later time, the LP-WUR 1056 may set internal registers for the main radio 1070 to tune to a different RU next time it is awake, the LP-WUR 1056 may wake up the main radio 1070 to transmit a signal, the LP-WUR 1056 may wake-up the main radio 1070 to be prepared to receive data. etc.

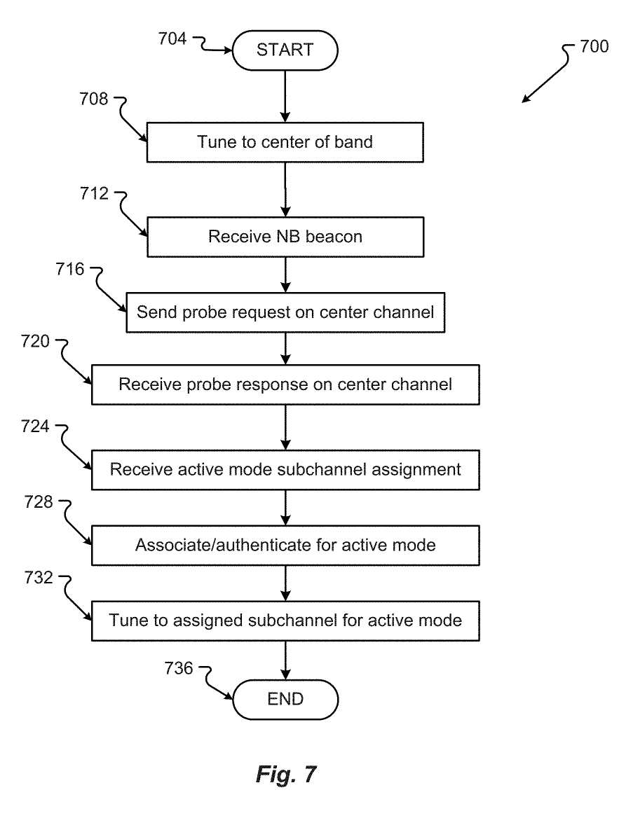

An embodiment of a method 700 for conducting NB communications may be as shown in FIG. 7. The method 700 may be from the perspective of the unassociated LP-NB device 116. A general order for the steps of the method 700 is shown in FIG. 7. Generally, the method 700 starts with a start operation 704 and ends with an end operation 736. The method 700 can include more or fewer steps or can arrange the order of the steps differently than those shown in FIG. 7. The method 700 can be executed as a set of computer-executable instructions executed by a computer system or processor and encoded or stored on a computer readable medium. Hereinafter, the method 700 shall be explained with reference to the systems, components, circuits, modules, software, data structures, signalling processes, etc. described in conjunction with FIGS. 1-6 and 10.

In step 708, the unassociated device 116 can tune to the central subchannel 208 to receive NB beacons 512. The unassociated device 116 can receive a NB beacon 512 on the center subchannel 208, in step 712. Based on information in the LP-NB header 516 or the beacon body 512, the unassociated device 116 can send a probe request to the AP 102 on the center subchannel 208, in step 716. In response to the probe request, the AP 102 can send and the unassociated device 116 can receive a probe response on the center subchannel 208, in step 720.

In step 724, the device 116 can receive, in the beacons 512 and/or probe responses, information to determine the device's active mode subchannel assignment 508. The device 116 can then complete any association/authentication exchange, for active mode, on the assigned subchannel 508 or on the central subchannel 208, in step 728, depending on the information obtained in the beacons 512 or probe responses. Thereinafter, the STA 116 is associated and can tune to the STA's assigned subchannel for active mode, in step 732.

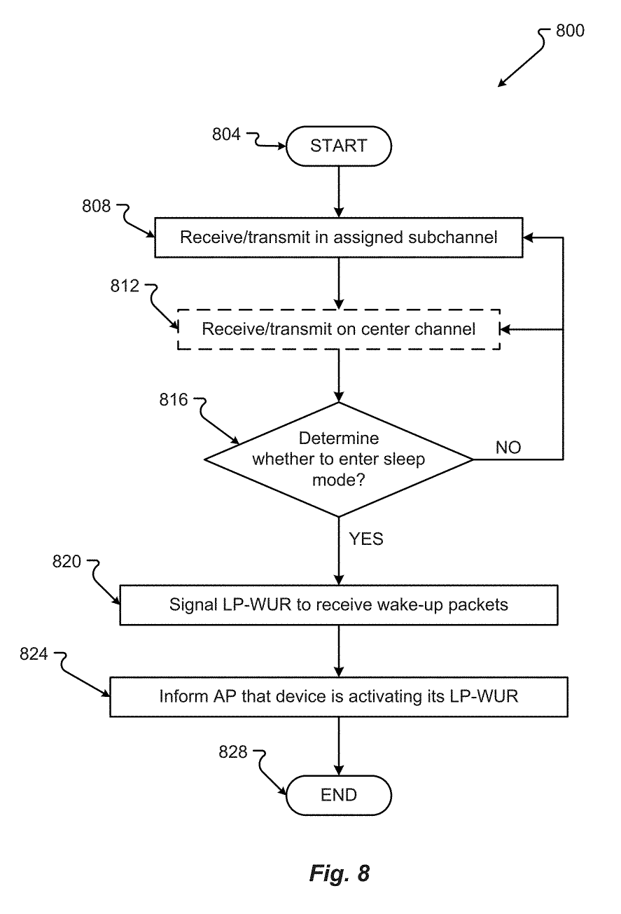

An embodiment of a method 800 for conducting NB communications may be as shown in FIG. 8. The method 800 may be from the perspective of the associated LP-NB device 116. A general order for the steps of the method 800 is shown in FIG. 8. Generally, the method 800 starts with a start operation 804 and ends with an end operation 824. The method 800 can include more or fewer steps or can arrange the order of the steps differently than those shown in FIG. 8. The method 800 can be executed as a set of computer-executable instructions executed by a computer system or processor and encoded or stored on a computer readable medium. Hereinafter, the method 800 shall be explained with reference to the systems, components, circuits, modules, software, data structures, signalling processes, etc. described in conjunction with FIGS. 1-7 and 10.

The LP-NB device (STA) 116 operates on the STA's assigned subchannel 508, and the STA 116 can receive and/or transmit data, on the assigned subchannel 508, in step 808. Optionally, the STA 116 can also receive and/or transmit control and management packets 512, 300, etc. on the center subchannel 208 while in active mode, in step 812.

At some time, the controller 1070 determine whether the device 116 should enter sleep mode, in step 816. If the controller 1070 determines that the device 116 is not to enter sleep mode, the method 800 proceeds NO back to step 808 or step 812. If the controller 1070 determines that the device 116 is to enter sleep mode, the method 800 proceeds YES to step 820.

In step 820, when controller 1070 intends to go to sleep mode, the controller 1070 can signal the LP-WUR 1056, which is tuned to the central subchannel 208, to receive wake-up packets 300. Further, the STA 116 can inform the AP 102 that the device 116 is activating the LP-WUR 1056, in step 824. The STA 116 can inform the AP 102 by sending a control packet either on the assigned subchannel 508 or the center subchannel 208.

In contrast, if the STA 116 is not using the LP-WUR 1056, the STA 116 can waken periodically and tune to the central 26-tone subchannel 208 to receive beacons 516, 512 and other broadcast/multicast packets. The STA 116 can also remain tuned to the STA's assigned subchannel 508 to receive, periodically, mini-beacons or other control packets. A mini-beacon can be different from a beacon 516, 512. The mini-beacon may contain a subset of the information fields that are contained in a regular beacon. Regular beacons can contain all system information that is not changed very often. Only those data that are dynamically changed, such as, TSF timer, TIM, etc. may be needed in a mini-beacon. Once a STA 116 is in awake mode, the main radio 1070 can listen to normal beacons and receive updated general system information.

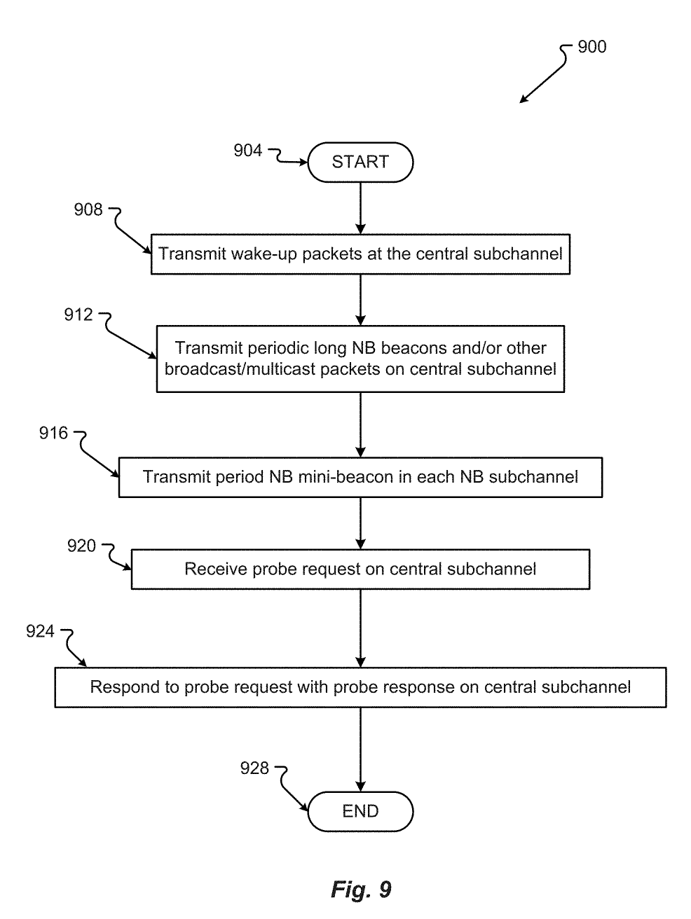

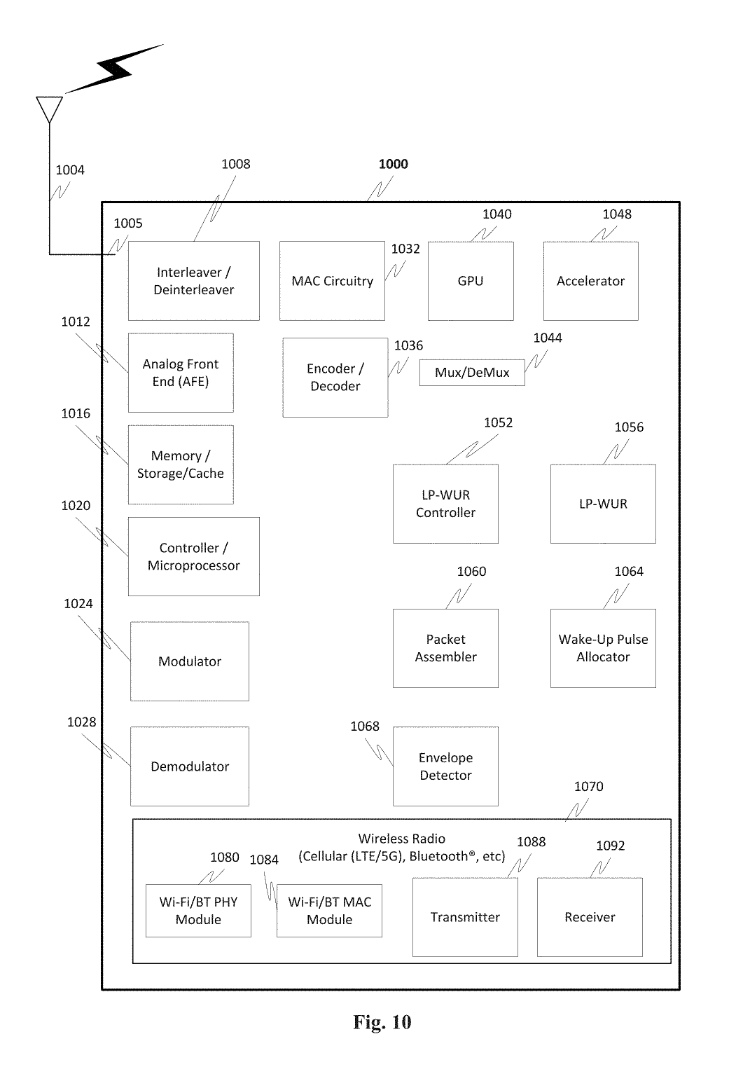

An embodiment of a method 900 for conducting NB communications may be as shown in FIG. 9. The method 900 may be from the perspective of the AP 102. A general order for the steps of the method 900 is shown in FIG. 9. Generally, the method 900 starts with a start operation 904 and ends with an end operation 936. The method 900 can include more or fewer steps or can arrange the order of the steps differently than those shown in FIG. 9. The method 900 can be executed as a set of computer-executable instructions executed by a computer system or processor and encoded or stored on a computer readable medium. Hereinafter, the method 900 shall be explained with reference to the systems, components, circuits, modules, software, data structures, signalling processes, etc. described in conjunction with FIGS. 1-8 and 10.

The AP 102 can transmit wake-up packets 300, at the central subchannel 208, in step 908. In other circumstances, the AP 102 can transmit periodic (or aperiodic) mini-beacons on the central subchannel 208, and it may transmit periodic long NB beacons 516, 512 and/or other broadcast/multicast signals, on the central subchannel 208, in step 912. Further, the AP 102 may transmit periodic NB mini-beacons in each NB subchannels 508, in step 916. As described in conjunction with FIG. 7, the AP can receive probe requests, in step 920, and transmit probe responses, in step 924, on the central 26-tone subchannel 208 or other subchannels. Thus, the AP 102 can use the center subchannel 208 or NB RUs to efficiently manage the bandwidth for legacy devices, LP-NB devices, and/or IEEE 802.11ax devices.

In summary, the AP 102 can define the central 26-tone allocation 208 to be a dedicated subchannel for communicates with LP-WURs 1056; the AP 102 can also employ the central subchannel 208 as a control/management subchannel for future NB and LP devices. Future LP-NB IoT and sensor devices may operate on any of the 11ax 26-tone subchannels 508 (or a combination of them, such as 52-tone), excluding the central 26-tone allocation 208, which will be dedicated to transmission of wake-up packets 300, broadcast/multicast control and management frames, unicast management frames (such as probe req/res), and occasionally for legacy 11ax data transmission.

FIG. 10 illustrates an exemplary hardware diagram of a device 1000, such as a NB station(s) 116a, 116b, AP 102, AS 112 STAs 104, or the like, that is adapted to implement the technique(s) discussed herein.

In addition to well-known componentry (which has been omitted for clarity), the device 1000 includes interconnected elements including one or more of: one or more antennas 1004, an interleaver/deinterleaver 1008, an analog front end (AFE) 1012, memory/storage/cache 1016, controller/microprocessor 1020, MAC circuitry 1032, modulator 1024, demodulator 1028, encoder/decoder 1036, GPU 1040, accelerator 1048, a multiplexer/demultiplexer 1044, LP-WUR controller 1052, LP-WUR 1056, packet assembler 1060, wake-up pulse allocator 1064, envelope detector 1068 and wireless radio 1070 components such as a Wi-Fi PHY module/circuit 1080, a Wi-Fi/BT MAC module/circuit 1084, transmitter 1088 and receiver 1092. The various elements in the device 1000 are connected by one or more links/connections (not shown, again for sake of clarity).

The device 1000 can have one more antennas 1004, for use in wireless communications such as Wi-Fi, multi-input multi-output (MIMO) communications, multi-user multi-input multi-output (MU-MIMO) communications Bluetooth®, LTE, 5G, 60 Ghz, WiGig, mmWave systems, etc. The antenna(s) 1004 can include, but are not limited to one or more of directional antennas, omnidirectional antennas, monopoles, patch antennas, loop antennas, microstrip antennas, dipoles, and any other antenna(s) suitable for communication transmission/reception. In one exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 1004 generally interact with the Analog Front End (AFE) 1012, which is needed to enable the correct processing of the received modulated signal and signal conditioning for a transmitted signal. The AFE 1012 can be functionally located between the antenna and a digital baseband system in order to convert the analog signal into a digital signal for processing, and vice-versa.

The device 1000 can also include a controller/microprocessor 1020 and a memory/storage/cache 1016. The device 1000 can interact with the memory/storage/cache 1016 which may store information and operations necessary for configuring and transmitting or receiving the information described herein. The memory/storage/cache 1016 may also be used in connection with the execution of application programming or instructions by the controller/microprocessor 1020, and for temporary or long term storage of program instructions and/or data. As examples, the memory/storage/cache 1020 may comprise a computer-readable device, RAM, ROM, DRAM, SDRAM, and/or other storage device(s) and media.

The controller/microprocessor 1020 may comprise a general purpose programmable processor or controller for executing application programming or instructions related to the device 1000. Furthermore, the controller/microprocessor 1020 can cooperate with one or more other elements in the device 1000 to perform operations for configuring and transmitting information as described herein. The controller/microprocessor 1020 may include multiple processor cores, and/or implement multiple virtual processors. Optionally, the controller/microprocessor 1020 may include multiple physical processors. By way of example, the controller/microprocessor 1020 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 1000 can further include a transmitter 1088 and receiver 1092 which can transmit and receive signals, respectively, to and from other wireless devices and/or access points using the one or more antennas 1004. Included in the device 1000 circuitry is the medium access control or MAC Circuitry 1032. MAC circuitry 1032 provides for controlling access to the wireless medium. In an exemplary embodiment, the MAC circuitry 1032 may be arranged to contend for the wireless medium and configure frames or packets for communicating over the wireless medium.

The device 1000 can also optionally contain a security module (not shown). This security module can contain information regarding but not limited to, security parameters required to connect the device to an access point or other device, or vice versa, or other available network(s), and can include WEP or WPA/WPA-2 (optionally+AES and/or TKIP) security access keys, network keys, etc. As an example, the WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

The exemplary device 1000 can also include a GPU 1040, an accelerator 1048, multiplexer/demultiplexer 1044, a Wi-Fi/BT/BLE PHY module 1080 and a Wi-Fi/BT/BLE MAC module 1084 that at least cooperate with one or more of the other components as discussed herein. In operation, exemplary behavior of a wireless system commences with the transmitter side of a communication system including, for example, two or more of the wireless devices 1000.

When it is determined that wake-up of a main radio is required, the LP-WUR controller 1052, communicating with the packet assembler 1060, wake-up pulse allocator 1064, controller 1020 and memory 1016 assemble a wake-up pulse for a wake-to packet to be transmitted to a receiving transceiver, to wake-up the main radio of the receiving transceiver.

As discussed, the packet assembler 1060 and wake-up pulse allocator 1064 allocate the wake-up pulse to the approximate center of the band without nulling the central subcarriers around DC. The LP-WUR controller 1052, communicating with the packet assembler 1060, wake-up pulse allocator 1064, controller 1020 and memory 1016 also allocate guard bands around the wake-up pulse.

The LP-WUR controller 1052, communicating with the packet assembler 1060, wake-up pulse allocator 1064, controller 1020 and memory 1016 then allocate subcarrier indices corresponding to IEEE 802.11ax RUs.

The transmitter 1088 then transmits the wake-up packet.

At the receiving transceiver, the LP-WUR 1056 receives the wake-up packet. Demodulator 1028 demodulates the received wake-up packet and uses the envelope detector 1068 to detect the wake-up pulse in the wake-up packet. The LP-WUR 1056 then triggers the wake-up of one or more wireless radio components 1070-1092.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments are described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links 5, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to enhanced GFDM communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:

A wireless communications device comprising: a Low-Power Wake-Up Radio (LP-WUR) controller that assembles a wake-up pulse for a wake-up packet; the LP-WUR controller communicating with a packet assembler, a wake-up pulse allocator and a processor to: allocate the wake-up pulse to the approximate center of a band (center subchannel); a controller to assign a subchannel to a narrowband (NB) station (STA) subcarrier indices corresponding to resource units (RUs); and a transceiver to: transmit the packet with the wake-up pulse on the center subchannel; and transmit and/or receive data from the NB STA on the assigned subchannel.

Any of the one or more above aspects, wherein the assigned subchannel is a NB portion associated with a IEEE 802.11ax resource unit (RU).

Any of the one or more above aspects, allocate narrowband (NB) long beacons or mini-beacons to the center subchannel.

Any of the one or more above aspects, wherein the transceiver transmits NB long beacons or mini-beacons on the center subchannel.

Any of the one or more above aspects, in response to the NB long beacons or mini-beacons, the transceiver sends a probe request for the NB STA to associated with the wireless communications device.

Any of the one or more above aspects, wherein the controller allocates narrowband (NB) mini-beacons to the assigned subchannel.

Any of the one or more above aspects, wherein the transmitter transmits NB mini-beacons on the assigned subchannel.

Any of the one or more above aspects, wherein the wake-up packet comprises a preamble, header, and a frame body.

Any of the one or more above aspects, wherein RUs 1-4 and RUs 6-9 are IEEE 802.11ax resource units.

Any of the one or more above aspects, further comprising one or more connected elements including a receiver, a modulator/demodulator, an interleaver/deinterleaver, an analog front end, a GPU, an accelerator, an encoder/decoder, one or more antennas, a processor and memory.

A method comprising: an access point (AP) assembling a wake-up pulse for a wake-up packet; the AP allocating the wake-up pulse to the approximate center of a band (center subchannel); the AP assigning a subchannel to a narrowband (NB) station (STA) subcarrier indices corresponding to resource units (RUs); the AP transmitting the packet with the wake-up pulse on the center subchannel; and the AP transmitting and/or receive data from the NB STA on the assigned subchannel.

Any of the one or more above aspects, wherein the assigned subchannel is a NB portion associated with a IEEE 802.11ax resource unit (RU).

Any of the one or more above aspects, further comprising the AP allocating narrowband (NB) long beacons or mini-beacons to the center subchannel.

Any of the one or more above aspects, wherein the AP transmits NB long beacons or mini-beacons on the center subchannel.

Any of the one or more above aspects, in response to the NB long beacons or mini-beacons, sending a probe request for the NB STA to associate with the AP.

Any of the one or more above aspects, wherein the AP allocates narrowband (NB) mini-beacons to the assigned subchannel.

Any of the one or more above aspects, wherein the AP transmits NB mini-beacons on the assigned subchannel.

Any of the one or more above aspects, wherein the wake-up packet comprises a preamble, header, and a frame body.

Any of the one or more above aspects, wherein RUs 1-4 and RUs 6-9 are IEEE 802.11ax resource units.

Any of the one or more above aspects, wherein the AP comprises one or more connected elements including a receiver, a modulator/demodulator, an interleaver/deinterleaver, an analog front end, a GPU, an accelerator, an encoder/decoder, one or more antennas, a processor and memory.

A wireless communications device comprising: means for assembling a wake-up pulse for a wake-up packet; means for allocating the wake-up pulse to an approximate center of a band (center subchannel); means for assigning a subchannel to a narrowband (NB) station (STA) subcarrier indices corresponding to resource units (RUs); means for transmitting the packet with the wake-up pulse on the center subchannel; and means for transmitting and/or receive data from the NB STA on the assigned subchannel.

Any of the one or more above aspects, wherein the assigned subchannel is a NB portion associated with a IEEE 802.11ax resource unit (RU).

Any of the one or more above aspects, further comprising means for allocating narrowband (NB) long beacons or mini-beacons to the center subchannel.

Any of the one or more above aspects, wherein the transceiver transmits NB long beacons or mini-beacons on the center subchannel.

Any of the one or more above aspects, in response to the NB long beacons or mini-beacons, means for sending a probe request for the NB STA to associate with means for.

Any of the one or more above aspects, further comprising means for allocating narrowband (NB) mini-beacons to the assigned subchannel.

Any of the one or more above aspects, further comprising means for transmitting NB mini-beacons on the assigned subchannel.

Any of the one or more above aspects, wherein the wake-up packet comprises a preamble, header, and a frame body.

Any of the one or more above aspects, wherein RUs 1-4 and RUs 6-9 are IEEE 802.11ax resource units.

Any of the one or more above aspects, wherein the means comprises one or more connected elements including a receiver, a modulator/demodulator, an interleaver/deinterleaver, an analog front end, a GPU, an accelerator, an encoder/decoder, one or more antennas, a processor and memory.

A non-transitory information storage media having stored thereon one or more instructions, that when executed by one or more processors, cause a wireless communications device to perform a method, the method comprising: assembling a wake-up pulse for a wake-up packet; allocating the wake-up pulse to proximate center of a band (center subchannel); assigning a subchannel to a narrowband (NB) station (STA) subcarrier indices corresponding to resource units (RUs); transmitting the packet with the wake-up pulse on the center subchannel; and transmitting and/or receive data from the NB STA on the assigned subchannel.

Any of the one or more above aspects, wherein the assigned subchannel is a NB portion associated with a IEEE 802.11ax resource unit (RU).

Any of the one or more above aspects, the method further comprising allocating narrowband (NB) long beacons or mini-beacons to the center subchannel.

Any of the one or more above aspects, the method further comprising transmitting NB long beacons or mini-beacons on the center subchannel.

Any of the one or more above aspects, in response to the NB long beacons or mini-beacons, the method further comprising sending a probe request for the NB STA to associate with.

Any of the one or more above aspects, the method further comprising allocating narrowband (NB) mini-beacons to the assigned subchannel.

Any of the one or more above aspects, the method further comprising transmitting NB mini-beacons on the assigned subchannel.

Any of the one or more above aspects, wherein the wake-up packet comprises a preamble, header, and a frame body.

Any of the one or more above aspects, wherein RUs 1-4 and RUs 6-9 are IEE 802.11ax resource units.

A non-transitory information storage media having stored thereon one or more instructions, that when executed by one or more processors, cause a wireless communications device to perform a method, the instructions comprising: instructions to receive assignment of a NB subchannel from an access point (AP); instructions to receive from and/or transmit to the AP first data on assigned NB subchannel; instructions to determine whether to enter sleep mode; if entering sleep mode, instructions to signal a low-power (LP) wake-up radio (WUR) (LP-WUR) to receive wake-up packets, from the AP, on an approximate center of a band (center subchannel); and if not entering sleep mode, instructions to continue to receive from and/or transmit to the AP first data on assigned NB subchannel.

Any of the one or more above aspects, further comprising instructions to receive from and/or transmit to the AP second data and/or control signals on the center subchannel.

Any of the one or more above aspects, wherein, if not entering sleep mode, instructions to continue to receive and/or transmit second data and/or control signals on the center subchannel.

Any of the one or more above aspects, further comprising instructions to inform the AP that the wireless communications device is activating the LP-WUR.

Any of the one or more above aspects, further comprising, while in sleep mode, instructions to wait for the wake-up packet.

A method comprising: receiving assignment of a NB subchannel from an access point (AP); receiving from and/or transmit to the AP first data on assigned NB subchannel; determining whether to enter sleep mode; if entering sleep mode, signaling a low-power (LP) wake-up radio (WUR) (LP-WUR) to receive wake-up packets, from the AP, on an approximate center of a band (center subchannel); and if not entering sleep mode, continuing to receive from and/or transmit to the AP first data on assigned NB subchannel.

Any of the one or more above aspects, further comprising receiving from and/or transmitting to the AP second data and/or control signals on the center subchannel.

Any of the one or more above aspects, wherein, if not entering sleep mode, continuing to receive and/or transmit second data and/or control signals on the center subchannel.

Any of the one or more above aspects, further comprising informing the AP that the wireless communications device is activating the LP-WUR.

Any of the one or more above aspects, further comprising, while in sleep mode, waiting for the wake-up packet.

A wireless communications device comprising: means for receiving assignment of a NB subchannel from an access point (AP); means for receiving from and/or transmit to the AP first data on assigned NB subchannel; means for determining whether to enter sleep mode; if entering sleep mode, means for signaling a low-power (LP) wake-up radio (WUR) (LP-WUR) to receive wake-up packets, from the AP, on an approximate center of a band (center subchannel); and if not entering sleep mode, means for continuing to receive from and/or transmit to the AP first data on assigned NB subchannel.

Any of the one or more above aspects, further comprising means for receiving from and/or means for transmitting to the AP second data and/or control signals on the center subchannel.

Any of the one or more above aspects, wherein, if not entering sleep mode, means for continuing to receive and/or transmit second data and/or control signals on the center subchannel.

Any of the one or more above aspects, further comprising means for informing the AP that the wireless communications device is activating the LP-WUR.

Any of the one or more above aspects, further comprising, while in sleep mode, means for waiting for the wake-up packet.

A wireless communications device comprising: a memory; a low-power wake-up radio (LP-WUR); a main radio; a processor in communication with the memory, the LP-WUR, and the main radio, the processor to: receive assignment of a NB subchannel from an access point (AP); receive from and/or transmit to the AP first data on assigned NB subchannel; determine whether to enter sleep mode; if entering sleep mode, signal a low-power (LP) wake-up radio (WUR) (LP-WUR) to receive wake-up packets, from the AP, on an approximate center of a band (center subchannel); and if not entering sleep mode, continue to receive from and/or transmit to the AP first data on assigned NB subchannel.

Any of the one or more above aspects, the processor further to receive from and/or to transmit to the AP second data and/or control signals on the center subchannel.

Any of the one or more above aspects, wherein, if not entering sleep mode, the processor further to continue to receive and/or transmit second data and/or control signals on the center subchannel.

Any of the one or more above aspects, the processor further to inform the AP that the wireless communications device is activating the LP-WUR.

Any of the one or more above aspects, while in sleep mode, the processor further to wait for the wake-up packet.

A wireless communications device comprising: means for tuning to an approximate center of a band (center subchannel); means for receiving narrowband (NB) long beacons on the center subchannel; in response to receiving a NB long beacon on the center subchannel, means for sending a probe request on the center subchannel; in response to sending a probe request on the center subchannel, means for receiving a probe response on the center subchannel; means for receiving an assignment of an subchannel for active mode operation; means for associating and/or authenticating for active mode operation on the assigned subchannel; and means for tuning to the assigned subchannel.

Any of the one or more above aspects, wherein the assigned subchannel is a NB portion associated with a IEEE 802.11ax resource unit (RU).

Any of the one or more above aspects, further comprising: means for entering a sleep mode; means for tuning to the center subchannel; means for searching for a wake-up preamble in a packet on the center subchannel; if the wake-up preamble is acquired on the center subchannel, means for: determining if the wake-up preamble is associated with a broadcast or multicast packet; and/or determining if the wake-up preamble is addressed to the wireless communications device; and if the wake-up preamble is not acquired on the center subchannel, means for continuing to search for a wake-up preamble on the center subchannel.

Any of the one or more above aspects, further comprising, if the wake-up preamble is associated with a broadcast or multicast packet: means for decoding the packet; and means for reacting as instructed in the decoded packet.

Any of the one or more above aspects, further comprising, if the wake-up preamble is addressed to the wireless communications device: means for waking a main radio of the wireless communications device; and means for operating on the assigned subchannel as previously assigned.

A method comprising: tuning to an approximate center of a band (center subchannel); receiving narrowband (NB) long beacons on the center subchannel; in response to receiving a NB long beacon on the center subchannel, sending a probe request on the center subchannel; in response to sending a probe request on the center subchannel, receiving a probe response on the center subchannel; receiving an assignment of an subchannel for active mode operation; associating and/or authenticating for active mode operation on the assigned subchannel; and tuning to the assigned subchannel.

Any of the one or more above aspects, wherein the assigned subchannel is a NB portion associated with a IEEE 802.11ax resource unit (RU).

Any of the one or more above aspects, further comprising: entering a sleep mode; tuning to the center subchannel; searching for a wake-up preamble in a packet on the center subchannel; if the wake-up preamble is acquired on the center subchannel: determining if the wake-up preamble is associated with a broadcast or multicast packet; and/or determining if the wake-up preamble is addressed to the wireless communications device; and if the wake-up preamble is not acquired on the center subchannel, continuing to search for a wake-up preamble on the center subchannel.

Any of the one or more above aspects, further comprising, if the wake-up preamble is associated with a broadcast or multicast packet: decoding the packet; and reacting as instructed in the decoded packet.

Any of the one or more above aspects, further comprising, if the wake-up preamble is addressed to the wireless communications device: waking a main radio of the wireless communications device; and operating on the assigned subchannel as previously assigned.

A non-transitory information storage media having stored thereon one or more instructions, that when executed by one or more processors, cause a wireless communications device to perform a method, the method comprising: tuning to an approximate center of a band (center subchannel); receiving narrowband (NB) long beacons on the center subchannel; in response to receiving a NB long beacon on the center subchannel, sending a probe request on the center subchannel; in response to sending a probe request on the center subchannel, receiving a probe response on the center subchannel; receiving an assignment of an subchannel for active mode operation; associating and/or authenticating for active mode operation on the assigned subchannel; and tuning to the assigned subchannel.

Any of the one or more above aspects, wherein the assigned subchannel is a NB portion associated with a IEEE 802.11ax resource unit (RU).

Any of the one or more above aspects, further comprising: entering a sleep mode;

tuning to the center subchannel; searching for a wake-up preamble in a packet on the center subchannel; if the wake-up preamble is acquired on the center subchannel, means for: determining if the wake-up preamble is associated with a broadcast or multicast packet; and/or determining if the wake-up preamble is addressed to the wireless communications device; and if the wake-up preamble is not acquired on the center subchannel, continuing to search for a wake-up preamble on the center subchannel.

Any of the one or more above aspects, further comprising, if the wake-up preamble is associated with a broadcast or multicast packet: decoding the packet; and reacting as instructed in the decoded packet.

Any of the one or more above aspects, further comprising, if the wake-up preamble is addressed to the wireless communications device: waking a main radio of the wireless communications device; and operating on the assigned subchannel as previously assigned.

A wireless communications device comprising: a memory; a low-power wake-up radio (LP-WUR); a main radio; a processor in communication with the memory, the LP-WUR, and the main radio, the processor to: tune to an approximate center of a band (center subchannel); receive narrowband (NB) long beacons on the center subchannel; in response to receiving a NB long beacon on the center subchannel, send a probe request on the center subchannel; in response to sending a probe request on the center subchannel, receive a probe response on the center sub channel; receive an assignment of an subchannel for active mode operation; associate and/or authenticate for active mode operation on the assigned subchannel; and tune to the assigned subchannel.

Any of the one or more above aspects, wherein the assigned subchannel is a NB portion associated with a IEEE 802.11ax resource unit (RU).

Any of the one or more above aspects, further comprising: enter a sleep mode;

tune to the center subchannel; search for a wake-up preamble in a packet on the center subchannel; if the wake-up preamble is acquired on the center subchannel: determine if the wake-up preamble is associated with a broadcast or multicast packet; and/or determine if the wake-up preamble is addressed to the wireless communications device; and if the wake-up preamble is not acquired on the center subchannel, continue to search for a wake-up preamble on the center subchannel.

Any of the one or more above aspects, further comprising, if the wake-up preamble is associated with a broadcast or multicast packet: decode the packet; and react as instructed in the decoded packet.

Any of the one or more above aspects, further comprising, if the wake-up preamble is addressed to the wireless communications device: wake a main radio of the wireless communications device; and operate on the assigned subchannel as previously assigned.

A system on a chip (SoC) including any one or more of the above aspects.

One or more means for performing any one or more of the above aspects.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhanced communications. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless communications device comprising:
a Low-Power Wake-Up Radio (LP-WUR) controller that assembles a wake-up pulse for a wake-up packet;
the LP-WUR controller communicating with a packet assembler, a wake-up pulse allocator, and a processor to:
allocate the wake-up pulse to the approximate center of a band (center subchannel);
a controller to assign a subchannel to a narrowband (NB) station (STA) subcarrier indices corresponding to resource units (RUs);
a transceiver to:
transmit the packet with the wake-up pulse on the center subchannel; and
transmit and/or receive data from the NB STA on the assigned subchannel.

2. The wireless communications device of claim 1, wherein the assigned subchannel is a NB portion associated with a IEEE 802.11ax resource unit (RU).

3. The wireless communications device of claim 1, allocate narrowband (NB) long beacons or mini-beacons to the center subchannel.

4. The wireless communications device of claim 3, wherein the transceiver transmits NB long beacons or mini-beacons on the center subchannel.

5. The wireless communications device of claim 4, in response to the NB long beacons or mini-beacons, the transceiver sends a probe request for the NB STA to associated with the wireless communications device.

6. The wireless communications device of claim 1, wherein the controller allocates narrowband (NB) mini-beacons to the assigned subchannel.

7. The wireless communications device of claim 6, wherein the transmitter transmits NB mini-beacons on the assigned subchannel.

8. The wireless communications device of claim 1, wherein the wake-up packet comprises a preamble, header, and a frame body.

9. The wireless communications device of claim 1, wherein RUs 1-4 and RUs 6-9 are 802.11ax resource units.

10. The wireless communications device of claim 1, further comprising one or more connected elements including a receiver, a modulator/demodulator, an interleaver/deinterleaver, an analog front end, a GPU, an accelerator, an encoder/decoder, one or more antennas, a processor and memory.

11. A non-transitory information storage media having stored thereon one or more instructions, that when executed by one or more processors, cause a wireless communications device to perform a method, the instructions comprising:
instructions to receive assignment of a NB subchannel from an access point (AP);
instructions to receive from and/or transmit to the AP first data on assigned NB subchannel;
instructions to determine whether to enter sleep mode;
if entering sleep mode, instructions to signal a low-power (LP) wake-up radio (WUR) (LP-WUR) to receive wake-up packets, from the AP, on an approximate center of a band (center subchannel); and
if not entering sleep mode, instructions to continue to receive from and/or transmit to the AP first data on assigned NB subchannel.

12. The media of claim 11, further comprising instructions to receive from and/or transmit to the AP second data and/or control signals on the center subchannel.

13. The media of claim 11, wherein, if not entering sleep mode, instructions to continue to receive and/or transmit second data and/or control signals on the center subchannel.

14. The media of claim 11, further comprising instructions to inform the AP that the wireless communications device is activating the LP-WUR.

15. The media of claim 14, further comprising, while in sleep mode, instructions to wait for the wake-up packet.

16. A wireless communications device comprising:
means for tuning to an approximate center of a band (center subchannel);
means for receiving narrowband (NB) long beacons on the center subchannel;
in response to receiving a NB long beacon on the center subchannel, means for sending a probe request on the center subchannel;
in response to sending a probe request on the center subchannel, means for receiving a probe response on the center subchannel;
means for receiving an assignment of an subchannel for active mode operation;
means for associating and/or authenticating for active mode operation on the assigned subchannel; and
means for tuning to the assigned subchannel.

17. The wireless communications device of claim 16, wherein the assigned subchannel is a NB portion associated with a IEEE 802.11ax resource unit (RU).

18. The wireless communications device of claim 16, further comprising:
means for entering a sleep mode;
means for tuning to the center subchannel;
means for searching for a wake-up preamble in a packet on the center subchannel;
if the wake-up preamble is acquired on the center subchannel, means for:
determining if the wake-up preamble is associated with a broadcast or multicast packet; and/or
determining if the wake-up preamble is addressed to the wireless communications device; and
if the wake-up preamble is not acquired on the center subchannel, means for continuing to search for a wake-up preamble on the center subchannel.

19. The wireless communications device of claim 16, further comprising, if the wake-up preamble is associated with a broadcast or multicast packet:
means for decoding the packet; and
means for reacting as instructed in the decoded packet.

20. The wireless communications device of claim 16, further comprising, if the wake-up preamble is addressed to the wireless communications device:
means for waking a main radio of the wireless communications device; and
means for operating on the assigned subchannel as previously assigned.
